(19) United States
(12) Patent Application Publication
(10) Pub. No.: US 2026/0349155 A1
(43) Pub. Date: Nov. 5, 2026

(54) NOTCH-TYPE ADSORPTION PRIVACY FILM

(71) Applicant: RIGHT GROUP CENTRAL CO., LTD., New Taipei (TW)

(72) Inventors: Chuan-En Li, New Taipei (TW); Yu-Yen Lee, New Taipei (TW)

(21) Appl. No.: 19/392,201

(22) Filed: Nov. 18, 2025

(30) Foreign Application Priority Data
Mar. 10, 2025 (TW) 114202382

(51) Int. Cl. G02B 5/22; G02B 1/14

(52) U.S. Cl. CPC G02B 5/22; G02B 1/14

(57) ABSTRACT

The invention relates to a notch-type adsorption privacy film, comprising: a privacy film body and a coating layer. The privacy filter body includes a functional film with multiple gratings that limit transmitted light to a defined viewing angle and a notch on at least one edge. The notch corresponds to the installation position of a functional component of the electronic device. A coating layer covers the privacy film body and has an opening aligned with the notch. At least one magnetic or non-magnetic adsorption member is embedded between the coating layer and the privacy film body. The height LF of the covering layer, the height LN of the notch, and the height LM of the adsorption member satisfy at least one of the following relations (1), (2), or (3):

(1) LF>LM>LN; (1)

(2) LF>LM=LN; (2)

(3) LF=LM≥LN. (3)

### CROSS REFERENCE TO RELATED APPLICATIONS

The present application claims the benefit of Taiwanese Patent Application No. 114202382 filed on Mar. 10, 2025, the contents of which are incorporated herein by reference in their entirety.

### TECHNICAL FIELD

The present invention relates to a notch-type adsorption privacy film, and more particularly to a notch-type adsorption privacy film with enhanced adhesion to electronic devices.

### BACKGROUND

With the widespread use of electronic devices and wireless networks, people today can easily access the internet anytime through their devices. However, while electronic devices offer convenience, they also increase the risk of confidential information being viewed by others nearby. To ensure information security, privacy films have become one of the key solutions for protecting sensitive data.

Privacy films can restrict the visible range of a screen, allowing only users directly in front of the display to clearly view the content, while those viewing from the side will see a blurred or darkened screen. This helps protect sensitive information. As a form of physical protection, privacy films effectively reduce the risk of shoulder surfing attacks, especially when entering passwords or handling confidential documents, providing an additional layer of security.

In general, the screen bezels of electronic devices, especially laptops, often contain metal components or areas compatible with magnetic materials. Therefore, to allow a privacy filter to be attached to an electronic device, a magnetic structure or embedded magnetic material is typically designed along the edges or top of the privacy filter. By utilizing the magnetic attraction, the privacy filter can be securely attached to the bezel of the device's screen, preventing it from slipping or falling off. Compared to traditional adhesive-based attachment methods, magnetic structures or embedded magnetic materials help avoid issues related to adhesive residue and keep the screen clean and tidy.

However, the magnetic adhesive structure or embedded magnetic materials of a privacy film are generally only applicable to electronic devices with standard screen bezels. Therefore, in some cases, they may not be suitable for electronic devices with non-standard screen bezels. Furthermore, when the magnetic adhesive force of the magnetic adhesive structure is insufficient, particularly when frequently moving or using electronic devices such as laptops at an angle, there is also the risk that the privacy film may easily slide or fall off.

In summary, to overcome the above-mentioned shortcomings, the electronics industry is in urgent need of developing a novel privacy screen capable of addressing the aforementioned issues.

### SUMMARY

Accordingly, the inventor of the present invention has devoted substantial research and development efforts and dedication, continuously achieving breakthroughs and innovations in the field. As a result, a privacy film product has been developed which, in addition to being free from the defects or problems of the conventional techniques described above and not being restricted in size, can be custom-adjusted or share dimensions with different electronic devices, automatically position itself according to the magnetic polarity of the device's bezel, and enhance the quality of modern life through novel technical means. Thus, the present invention has been accomplished.

That is, the primary objective of the present invention is to provide a privacy film that can be very securely adsorbed to the outer surface or bezel of an electronic device's screen, includes an adsorption member that may be either magnetic or non-magnetic, and can be freely detached from the electronic device. Furthermore, the privacy film not only effectively prevents others from peeking at the display screen, but also does not affect or degrade various excellent display performances of the electronic device, such as color, image quality, and clarity, and does not interfere with various functions of the electronic device, including photography, audio recording, video recording, sound playback, and audio reception.

To achieve the aforementioned objectives, according to a first aspect of the solution, the present invention provides a notch-type adsorption privacy film, which can be detachably mounted on the exterior of an electronic device to prevent others from viewing the display screen. The notch-type adsorption privacy film includes a privacy film body and a coating layer. The privacy film body includes, inside thereof, a functional film provided with a plurality of gratings configured to restrict transmitted light within an allowable viewing angle range to define a viewing area, and having a notch at an edge on at least one side. The notch corresponds to the installation position of a functional component of the electronic device so as to avoid shielding or covering all or part of the functional component. The coating layer is disposed on the privacy film body to cover its surface and has an opening corresponding to the notch.

Preferably, at least one adsorption member, which may or may not have inherent magnetism, is additionally disposed between the privacy film body and the coating layer.

More preferably, the height LF of the coating layer, the height LN of the notch, and the height LM of the adsorption member satisfy at least one of the following relationships (1), (2), and (3):

LF>LM>LN; (1)

LF>LM=LN; (2)

LF=LM≥LN. (3)

Furthermore, to achieve the aforementioned objectives, according to a second aspect of the solution, the present invention provides a notch-type adsorption privacy film, which is detachably mountable on an exterior of an electronic device to prevent others from peeking at a display screen. The notch-type adsorption privacy film comprises a privacy film body and a coating layer. the privacy film body includes, inside thereof, a functional film provided with a plurality of gratings configured to restrict transmitted light within an allowable viewing angle range to define a viewing area, and having a notch at an edge on at least one side. The notch corresponds to an installation position of a functional component of the electronic device so as to avoid blocking or covering a portion or the entirety of the functional component. The coating layer is disposed over the privacy film body to cover a surface of the privacy film body, and is provided with an opening corresponding to the notch.

Preferably, the embedded slot is configured such that at least one side thereof is aligned with and adjacent to an edge on one side of the privacy film body; or the embedded slot is configured such that it is not adjacent to any edge of the privacy film body. At least one adsorption member, which may or may not have inherent magnetism, is additionally disposed between the privacy film body and the coating layer.

More preferably, the height LF of the coating layer, the height LN of the notch, the height LM of the adsorption member, and the height LS of the embedded slot satisfy at least one of the following relationships (4), (5), and (6):

LF>LM>LS=LN; (4)

LF>LM=LN=LN (5)

LF=LM≥LS= (6)

Furthermore, in the present invention, the adsorption area on the electronic device comprises at least one selected from the group consisting of: an iron sheet, iron paper, a ferromagnetic material, a paramagnetic material, a diamagnetic material, an antiferromagnetic material, a ferrimagnetic material, and combinations thereof.

Furthermore, in one embodiment of the present invention, the adsorption member may be a single-layer structure comprising only one magnetic material layer, or it may be a multilayer structure comprising at least one magnetic material layer and at least one other material layer.

Furthermore, in one embodiment of the present invention, the magnetic material suitable for forming the magnetic material layer includes a material having inherent magnetism or a material without inherent magnetism. For example, the magnetic material may be at least one selected from the group consisting of: a ferromagnetic material, a paramagnetic material, a diamagnetic material, an antiferromagnetic material, a ferrimagnetic material, and combinations thereof.

More specifically, the magnetic material in the adsorption member may be an iron-based material comprising at least one selected from the group consisting of: sheet magnets, strip magnets, flexible magnets, arc magnets, permanent magnets, non-permanent magnets, natural magnets, electromagnets, heat-resistant magnets, iron, steel, ferrites, iron oxide (FeO), magnetite (Fe₃O₄), nickel-zinc ferrite (NiZnFe₂O₄), and cobalt-zinc ferrite (CoZnFe₂O₄); or an iron-containing alloy material or a non-iron-containing alloy material comprising at least one selected from the group consisting of: alloys formed from Fe, B, Rb, Sm, graphite, Al, Mn, Cu, Mg, Na, Ni, Co, Cr, Au, Ag, Zn, Bi, Al₂O₃, MnO, and CoO, and combinations thereof.

In addition, in a case where the adsorption member is a multilayer structure, at least one surface or both surfaces of the magnetic material layer on the upper and/or lower side thereof may further comprise a first wave-absorbing magnetic film and/or a second wave-absorbing magnetic film. The first wave-absorbing magnetic film and the second wave-absorbing magnetic film are respectively provided with at least one substrate selected from the group consisting of a PET film, a PU film, a PC film, and a TAC film. Furthermore, in terms of magnetization direction, magnetic pole distribution, and magnetic field distribution, the magnetic material applicable to the present invention may be an axially magnetized iron, or may be a single-sided multi-pole magnetized iron or a double-sided multi-pole magnetized iron.

Further, in one embodiment of the present invention, the adsorption member is circular, triangular, rectangular, square, fan-shaped, L-shaped, polygonal, or a combination thereof.

Further, in one embodiment of the present invention, the thickness of the adsorption member is between 0.1 mm and 1.0 mm.

Further, in one embodiment of the present invention, the number of adsorption members is one, two, or three or more.

Further, in one embodiment of the present invention, the magnetic force of the adsorption member is in the range of 400 gauss to 3500 gauss.

Further, in one embodiment of the present invention, the gratings are louver-type privacy microstructures.

Further, in one embodiment of the present invention, the front viewing angle of the privacy film is between ±15° and ±75°. The front viewing angle refers to the maximum angular range within which a user can clearly see the screen content, typically expressed in terms of horizontal or vertical angles.

Further, in the present invention, the electronic device is a wearable electronic device, a portable smart device, a smartphone, a mobile phone, a tablet, a notebook computer, or a desktop computer.

Further, in the present invention, the functional component includes at least one selected from the group consisting of an image capturing element, an audio transceiving element, an optical imaging element, and a digital transmission element.

Further, in one embodiment of the present invention, the notch-type adsorption privacy film further includes an auxiliary accessory configured to be installed on a surface of the privacy film body or on a bezel of the electronic device. The auxiliary accessory may have adhesiveness and/or magnetism, or may have neither adhesiveness nor magnetism. Furthermore, the auxiliary accessory may further include a fastening member, a hanger member, or a reinforcement member, configured to further secure the privacy film body to the bezel of the electronic device.

Hereinafter, with reference to the accompanying drawings of the present invention, detailed descriptions are provided regarding the objectives and effects of the present invention, as well as the constituent components, structures, and other features of the disclosed notch-type adsorption privacy film.

### BRIEF DESCRIPTION OF THE DRAWINGS

FIG. 1(A) to 1(F) are schematic diagrams of notch-type adsorption privacy films according to Embodiments 1-1 to 1-6 of the present invention.

FIG. 2(A) to 2(H) are side views of notch-type adsorption privacy films according to Embodiments 2-1 to 2-8 of the present invention.

FIG. 3(A) to 3(D) are side views of notch-type adsorption privacy films according to Embodiments 3-1 to 3-4 of the present invention.

FIG. 4(A) to 4(F) are schematic diagrams of notch-type adsorption privacy films according to Embodiments 4-1 to 4-6 of the present invention.

FIG. 5(A) to 5(F) are schematic diagrams of notch-type adsorption privacy films according to Embodiments 5-1 to 5-6 of the present invention.

FIG. 6(A) to 6(C) are cross-sectional views of notch-type adsorption privacy films according to Embodiments 6-1 to 6-3 of the present invention.

FIG. 7(A) to 7(C) are cross-sectional views of notch-type adsorption privacy films according to Embodiments 7-1 to 7-3 of the present invention.

FIG. 8(A) to 8(C) are cross-sectional views of notch-type adsorption privacy films according to Embodiments 8-1 to 8-3 of the present invention.

FIG. 9(A) to 9(F) are side views of notch-type adsorption privacy films according to Embodiments 9-1 to 9-6 of the present invention.

FIG. 10 is a side view of a notch-type adsorption privacy film according to Embodiment 10 of the present invention.

FIG. 11(A) to 11(D) are cross-sectional views of notch-type adsorption privacy films according to Embodiments 11-1 to 11-4 of the present invention.

FIG. 12 is a partial exploded schematic diagram of a notch-type adsorption privacy film according to Embodiment 12 of the present invention.

FIG. 13 is a partial exploded schematic diagram of a notch-type adsorption privacy film according to Embodiment 13 of the present invention.

### DETAILED DESCRIPTION

In order to provide a clearer understanding of the technical features, objectives, and effects of the present invention, specific embodiments of the invention are described in detail below with reference to the accompanying drawings. The detailed description and technical contents of the present invention are explained in conjunction with the drawings; however, the accompanying drawings are provided for reference and illustration purposes only and are not intended to limit the scope of the present invention.

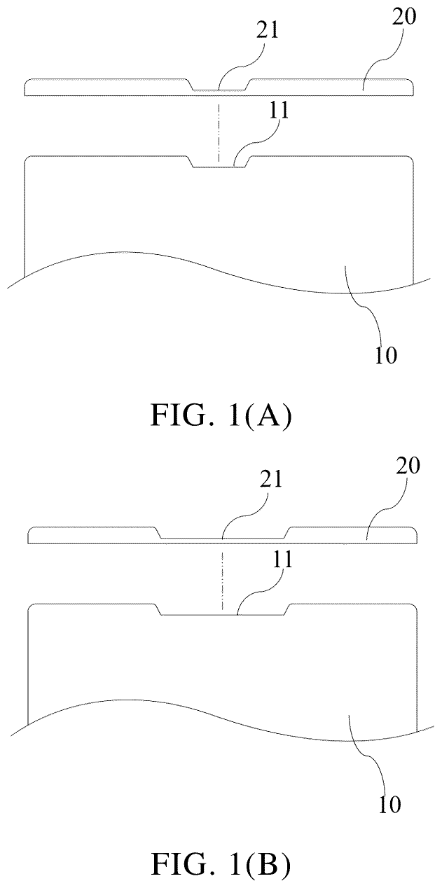

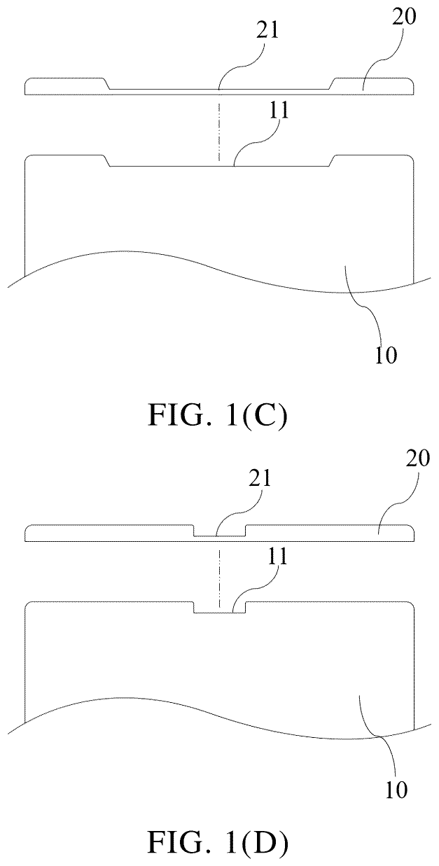

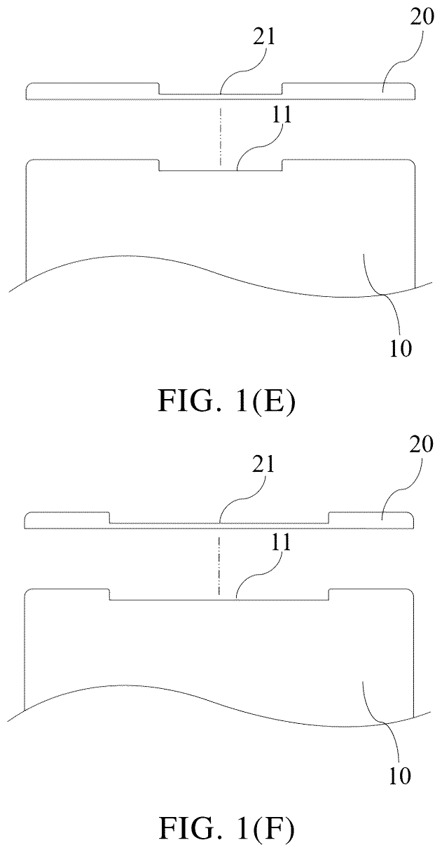

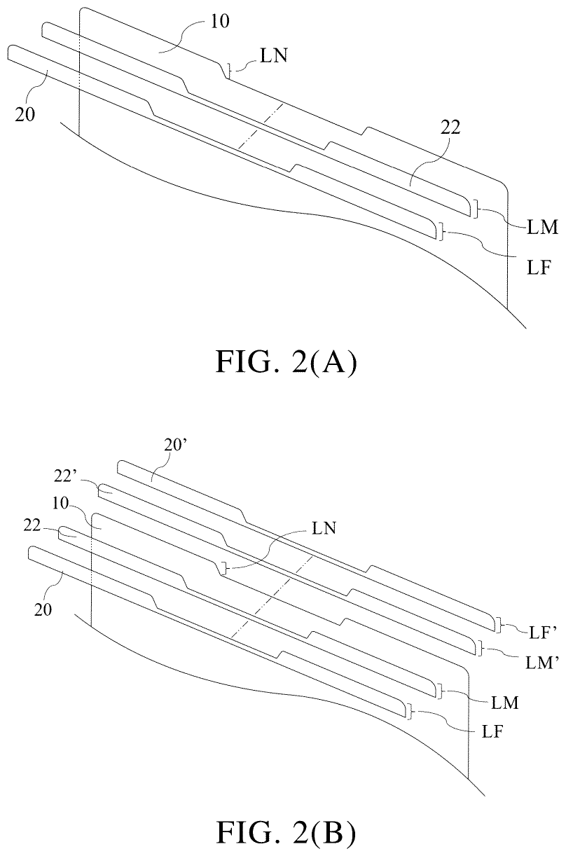

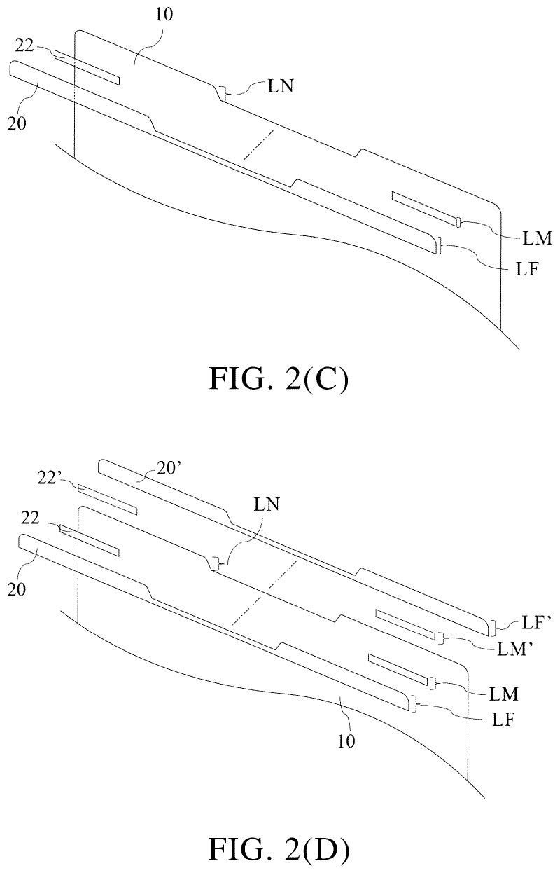

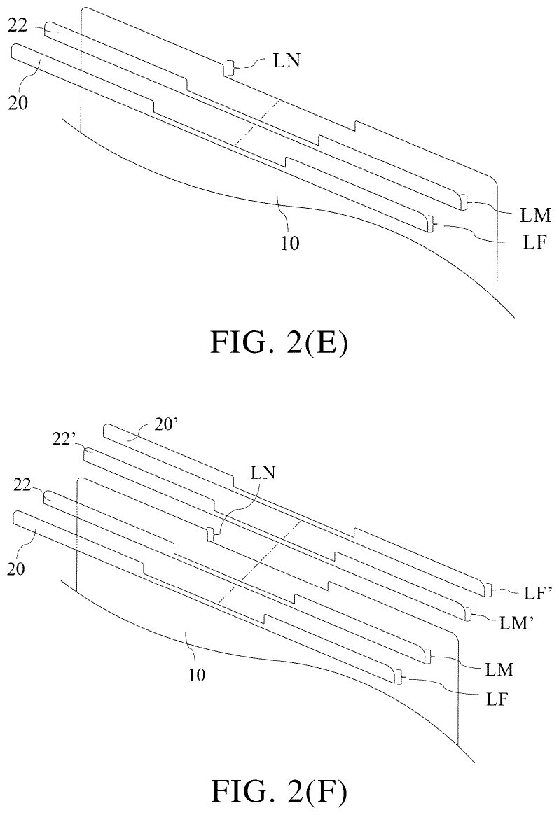

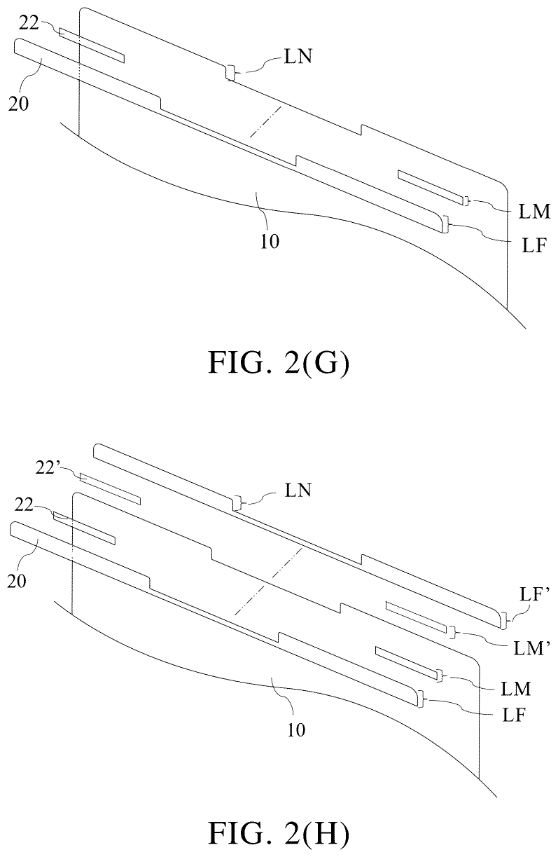

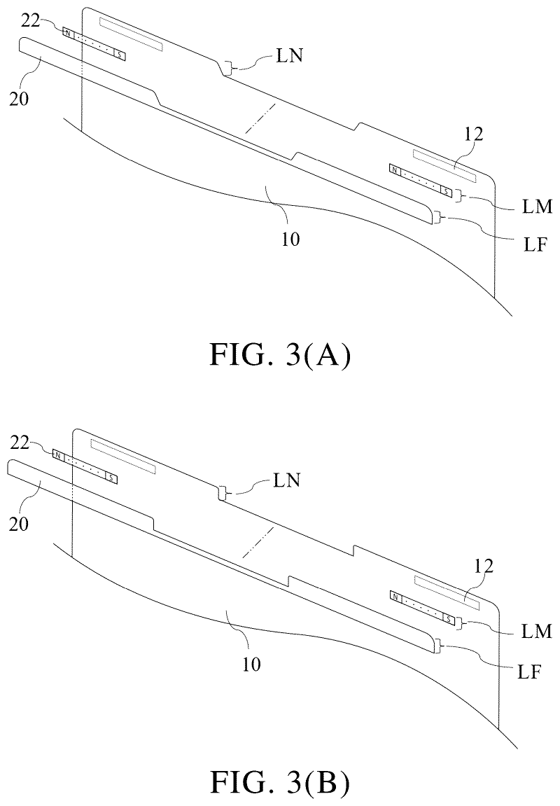

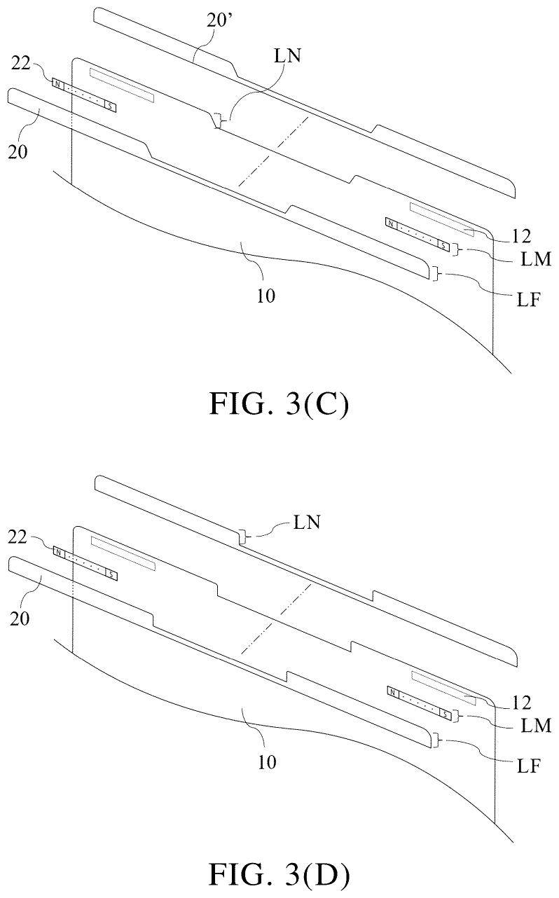

Referring to FIG. 1(A) to 1(F), 2(A) to 2(H), and 3(A) to 3(D), FIG. 1(A) to 1(F) are schematic diagrams of notch-type adsorption privacy films according to Embodiments 1-1 to 1-6 of the present invention; FIG. 2(A) to 2(H) are side views of notch-type adsorption privacy films according to Embodiments 2-1 to 2-8 of the present invention; and FIG. 3(A) to 3(D) are side views of notch-type adsorption privacy films according to Embodiments 3-1 to 3-4 of the present invention. In each of the aforementioned embodiments, the notch-type adsorption privacy film of the present invention at least comprises a privacy film body 10 having a notch 11, and a coating layer 20 disposed above the privacy film body 10 and having an opening 21 corresponding to the notch 11.

First, according to a first aspect of the solution of the present invention, the privacy film body 10 includes, inside thereof, a functional film provided with a plurality of gratings configured to restrict transmitted light within an allowable viewing angle range to define a viewing area, and having a notch 11 at an edge on at least one side. The notch 11 corresponds to an installation position of a functional component of the electronic device so as to avoid blocking or covering a portion or the entirety of the functional component.

As shown in FIG. 1(A) to 1(F), 2(A) to 2(H), and 3(A) to 3(D), the notch 11 of the present invention may be varied arbitrarily according to user requirements, the structure, and the shape of the electronic device. For example, the notch 11 may be square, rectangular, trapezoidal, circular, oval, triangular, or polygonal. Specifically, the styles of the notch 11 illustrated in Embodiments 1-1 to 1-3, Embodiments 2-1 to 2-4, Embodiment 3-1, and Embodiment 3-3 are trapezoidal; the notches illustrated in Embodiments 1-4 to 1-6, Embodiments 2-5 to 2-8, Embodiment 3-2, and Embodiment 3-4 are rectangular. However, the present invention is not limited thereto.

Furthermore, the gratings may be designed according to different requirements and are typically formed by alternating multiple layers of transparent materials and black opaque stripes to create louver-type privacy microstructures, allowing light to pass only within a certain angle range, thereby achieving a privacy effect. For example, the gratings may be linear gratings, oblique gratings, honeycomb gratings, hexagonal gratings, polygonal gratings, or combination thereof.

Secondly, although a smaller front viewing angle indicates better privacy protection and narrower viewing angle, excessively limiting the line of sight may cause inconvenience when viewing the screen. Therefore, users can select a suitable angular range according to their privacy needs. For example, the front viewing angle of the gratings may be between ±15° and ±75°, preferably between ±20° and ±70°, more preferably between ±25° and ±65°, and most preferably between ±30° and ±60°.

The electronic device applicable to the notch-type adsorption privacy film of the present invention is not particularly limited. For example, the electronic device may be a wearable electronic device, a portable smart device, a smartphone, a mobile phone, a tablet, a notebook computer, or a desktop computer. The functional component includes at least one selected from the group consisting of an image capturing element, an audio transceiving element, an optical imaging element, a digital transmission element, a photosensitive element, and an image recognition element.

Further, at least a portion of the bezel of the electronic device typically includes a non-magnetic iron member, a magnetic iron member, an iron member, or a magnetic material, to which the notch-type adsorption privacy film of the present invention can be adsorbed. The magnetic material includes materials with inherent magnetism or materials without inherent magnetism. The non-magnetic iron member may be metal iron or iron alloy. The magnet may be at least one selected from the group consisting of sheet magnets, strip magnets, flexible magnets, arc magnets, permanent magnets, non-permanent magnets, natural magnets, electromagnets, and heat-resistant magnets. The magnetic material may be any magnetic material selected from the group consisting of iron sheets, iron paper, ferromagnetic materials, paramagnetic materials, diamagnetic materials, antiferromagnetic materials, ferrimagnetic materials, and combinations thereof.

Secondly, the coating layer 20 is disposed above the privacy film body 10 to cover the surface of the privacy film body 10 and includes an opening 21 corresponding to the notch 11. At least one adsorption member 22, which may or may not have inherent magnetism, is additionally disposed between the privacy film body 10 and the coating layer 20. The adsorption member 22 may be an axially magnetized iron, a single-sided multi-pole magnetized iron, or a double-sided multi-pole magnetized iron.

Further, in the present invention, the coating layer 20 may also be referred to as a protective layer. It generally refers to a thin layer, film, or sheet coated or applied on the privacy film body, adsorption member, substrate, base material, or the privacy film itself, providing properties such as anti-aging, anti-fouling, protection, corrosion resistance, abrasion resistance, waterproofing, antioxidation, appearance improvement, high-temperature resistance, or enhanced functionality. Moreover, in the present invention, the materials, formation methods, and manufacturing methods used to produce or form the coating layer or protective layer are not specifically limited and can be appropriately selected according to the final application, required properties, and the type of object to be coated.

For example, in the present invention, the coating layer or protective layer may be formed or fabricated from ceramic materials; rubber materials; glass materials; nanomaterials; metal materials such as zinc, aluminum, or copper; polymer materials such as epoxy resin, polyurethane, polycarbonate, polyester, or polyacrylate; or other materials. Furthermore, the coating layer or protective layer may be formed or fabricated by methods such as spraying, dipping, roll coating, electroplating, powder coating, vapor deposition, hot-dip plating, printing, coating application, layer formation, film fabrication, or other methods.

Further, the shape of the adsorption member 22 may be arbitrarily designed according to the requirements of the user or the electronic device. The shape of the adsorption member 22 may be rectangular, circular, oval, polygonal, and the number of adsorption members 22 may be one or more. As shown in FIG. 2(A), 2(B), 2(E), and 2(F), the adsorption member 22 may have a slightly elongated strip-like appearance with a recess near the center corresponding to the notch and the opening. As shown in FIG. 2(C), 2(D), 2(G), and 2(H), the adsorption member 22 may have a substantially rectangular appearance. As shown in FIG. 3(A) to 3(D), the adsorption member 22 may also have a substantially rectangular appearance. Moreover, the number of adsorption members 22 is not particularly limited and may be a single piece or multiple pieces such as two or more.

As shown in FIG. 3(A) and 3(D), the height LF of the coating layer 20, the height LN of the notch, and the height LM of the adsorption member satisfy at least one of the following relationships:

LF>LM>LN; (1)

LF>LM=LN; (2)

LF=LM≥LN. (3)

Further, in one embodiment of the present invention, the adsorption member 22 may be a single-layer structure having only one magnetic material layer, or may be a multi-layer structure comprising at least one magnetic material layer and at least one other material layer.

Further, in one embodiment of the present invention, the magnetic material applicable for forming the magnetic material layer includes materials with inherent magnetism or materials without inherent magnetism. For example, it may be at least one selected from the group consisting of iron sheets, iron paper, ferromagnetic materials, paramagnetic materials, diamagnetic materials, antiferromagnetic materials, ferrimagnetic materials, and combinations thereof.

In the present invention, the term “ferromagnetic materials” refers to materials exhibiting strong magnetism that can generate persistent magnetization under the influence of an external magnetic field and retain magnetization after the external magnetic field is removed. Examples include at least one selected from iron (Fe), nickel (Ni), cobalt (Co), steel, ferrites, boron (B), rubidium (Rb), samarium (Sm), and alloys thereof.

Further, the term “paramagnetic materials” refers to materials that exhibit weak magnetism under the influence of an external magnetic field but do not retain magnetization after the magnetic field is removed. Examples include at least one selected from aluminum (Al), manganese (Mn), copper (Cu), magnesium (Mg), and sodium (Na).

In the present invention, the term “diamagnetic materials” refers to materials that exhibit a weak opposing magnetism under the influence of an external magnetic field and do not retain magnetization. Examples include at least one selected from copper (Cu), gold (Au), silver (Ag), zinc (Zn), aluminum oxide (Al₂O₃), graphite, and bismuth (Bi).

Further, the term “antiferromagnetic materials” refers to materials in which magnetic moments are oriented in opposite directions to mutually cancel each other, resulting in zero overall magnetism under an external magnetic field. Examples include at least one selected from manganese oxide (MnO), iron oxide (FeO), chromium (Cr), and cobalt oxide (CoO).

In the present invention, the term “ferrimagnetic materials” refers to materials similar to antiferromagnetic materials, but with oppositely oriented magnetic moments of unequal magnitude, resulting in incomplete cancellation and thus a net magnetization. Examples include at least one selected from iron oxide (FeO), magnetite (Fe₃O₄), nickel-zinc ferrite (NiZnFe₂O₄), and cobalt-zinc ferrite (CoZnFe₂O₄).

More specifically, the magnetic material in the adsorption member may be an iron-containing material selected from at least one of sheet magnets, strip magnets, flexible magnets, arc magnets, permanent magnets, non-permanent magnets, natural magnets, electromagnets, heat-resistant magnets, iron, steel, ferrites, iron oxide (FeO), magnetite (Fe₃O₄), nickel-zinc ferrite (NiZnFe₂O₄), and cobalt-zinc ferrite (CoZnFe₂O₄); or may be an iron-containing alloy material or a non-iron-containing alloy material selected from at least one of alloys and combinations formed from Fe, B, Rb, Sm, graphite, Al, Mn, Cu, Mg, Na, Ni, Co, Cr, Au, Ag, Zn, Bi, Al₂O₃, MnO, and CoO.

Additionally, when the adsorption member is a multilayer structure, one or both surfaces on either the upper or lower side of the magnetic material layer may further include a first microwave absorbing magnetic film and/or a second microwave absorbing magnetic film. The first microwave absorbing magnetic film and the second microwave absorbing magnetic film each comprise at least one substrate selected from PET film, PU film, PC film, and TAC film.

Furthermore, in the present invention, based on magnetization direction, pole distribution, and magnetic field distribution, the adsorption member may be an axially magnetized iron, a single-sided multipolar magnetized iron, or a double-sided multipolar magnetized iron.

Further, in the present invention, the so-called axially magnetized iron typically has only two magnetic poles, with the magnetization direction along the longitudinal axis (axial direction) of the object. The magnetic field extends from one end to the other, forming simple south(S) and north (N) poles at the two ends of the object, with a uniform magnetic field strength. The so-called single-sided multipolar magnetized iron usually has multiple staggered magnetic poles distributed on the same side, with the magnetization direction forming a complex magnetic field of multiple pole distributions on the same plane of one side of the object. The poles and magnetic field create local variations on the same side, resulting in non-uniform magnetic field strength. The so-called double-sided multipolar magnetized iron refers to magnetized iron that has single-sided multipolar magnetization on both sides.

Furthermore, the operating temperature range of the magnet is generally below 100 °C, and it should be prevented from being exposed to environments exceeding this temperature for extended periods, so as to ensure magnetic stability and service life. The adsorption member 22 may have its upper, lower, left, right, and both side surfaces further processed by zinc plating, epoxy resin coating, or rust-proof materials to isolate contact with air. In one embodiment, the first wave-absorbing magnetic film 221 and the second wave-absorbing magnetic film 222 may be fixed onto the adsorption member 22 by a PU adhesive or an acrylic adhesive, wherein the thickness of the acrylic adhesive is between 15 μm and 100 μm, and the adhesive strength ranges from 30 g to 1800 g.

After the adsorption member 22 is covered with the coating layer 20, the adsorption force or magnetic force will inevitably be reduced, and in some cases, it may only retain about 50% to 60% of the original magnetism. Therefore, to reduce the loss of adsorption force or magnetic force, a first wave-absorbing magnetic guiding film 221 and/or a second wave-absorbing magnetic guiding film 222 can be further disposed on the surface of the magnetic material. In this way, the adsorption magnetic force or magnetic force can generally be increased from 50%-60% to 70%-85%. The magnetic force of the adsorption member ranges from 400 gauss to 3500 gauss, preferably from 1000 gauss to 3500 gauss, more preferably from 1500 gauss to 3500 gauss, and most preferably from 2000 gauss to 3500 gauss.

Furthermore, the adsorption member 22 may be arranged in a singular or plural manner according to polarity, without depending on the polarity of the display screen magnets or when the display screen has no magnetic function; alternatively, the adsorption member 22 may be arranged in a singular or plural manner corresponding to the polarity of the display screen magnets.

The thickness of the adsorption member 22 is between 0.1 mm and 1.0 mm, and can be arbitrarily varied according to the needs of the user or the electronic device. The preferred thickness of the adsorption member 22 is between 0.2 mm and 0.7 mm; more preferably between 0.3 mm and 0.6 mm; and most preferably between 0.4 mm and 0.5 mm. Since the thickness of the adsorption member is within the range of 0.1 mm to 1.0 mm, it is prone to breakage, chipping, or snapping due to processing, bonding, or improper use by the user, which reduces its magnetism and renders it unusable. However, after the adsorption member 22 is coated with the first wave-absorbing magnetic guiding film 221 and the second wave-absorbing magnetic guiding film 222, it can still be firmly fixed even after breakage or snapping, thereby maintaining its original magnetic functionality.

The shape of the adsorption member 22 can be arbitrarily varied according to the user's requirements or the shape of the electronic device. The adsorption member may be circular, triangular, rectangular, square, fan-shaped, L-shaped, polygonal, or a combination thereof; however, the present invention is not limited thereto. In addition, the number of adsorption members 22 can be arbitrarily varied according to the user's requirements or the shape of the electronic device. The number of adsorption members may be one, two, or three or more; however, the present invention is not limited thereto.

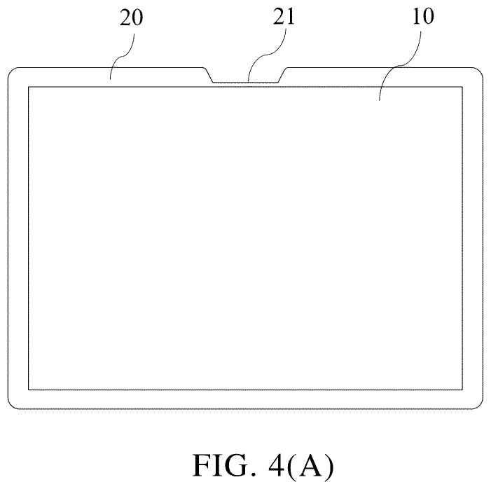

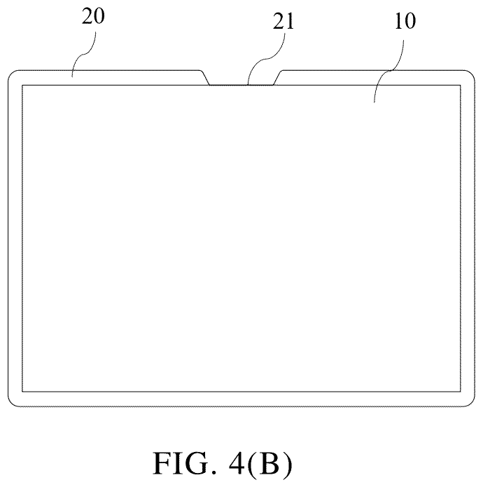

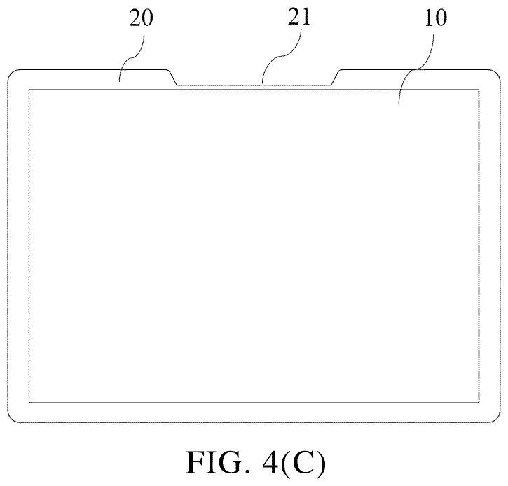

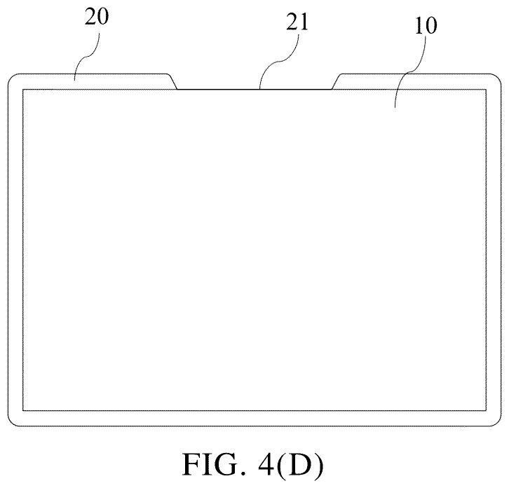

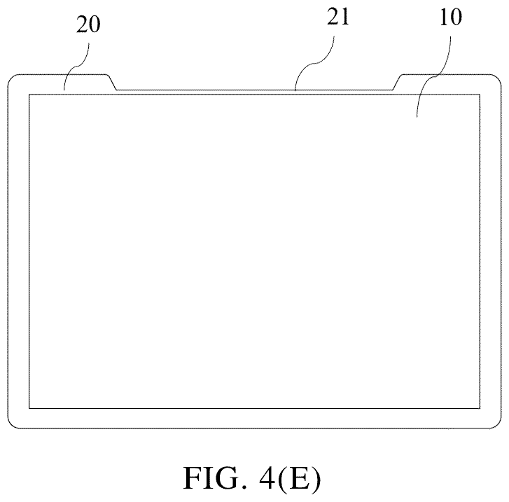

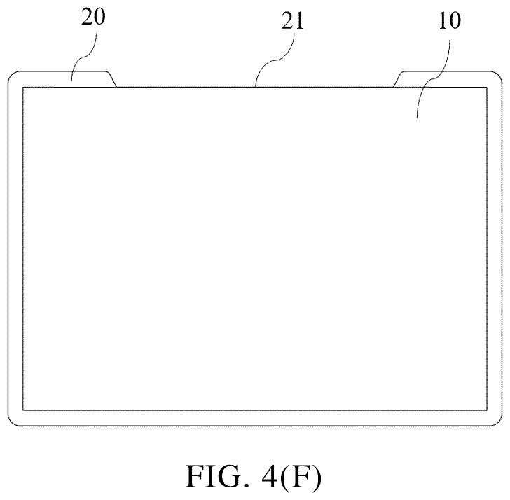

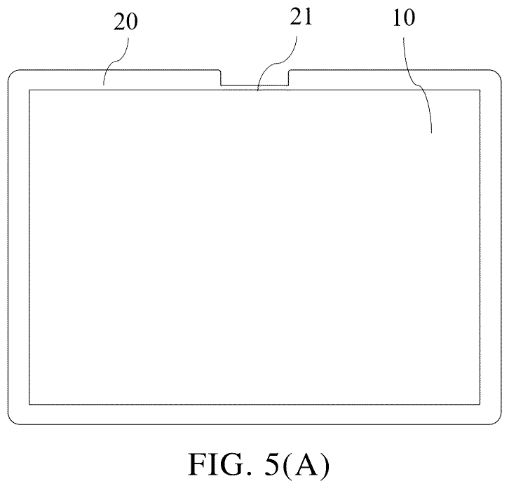

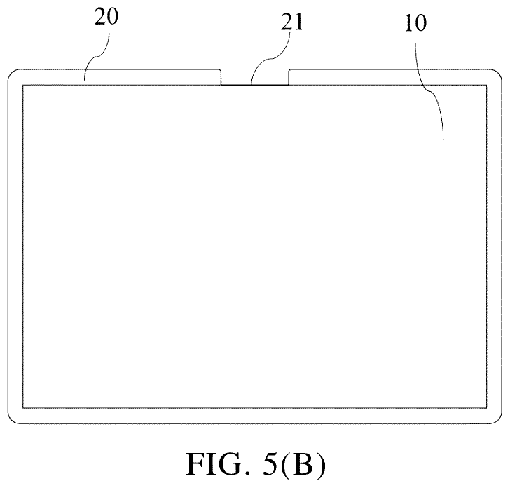

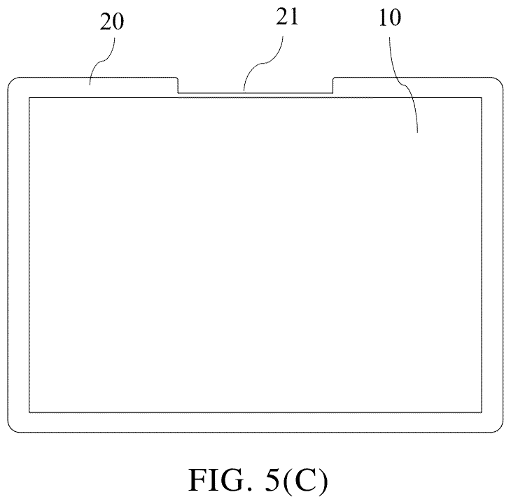

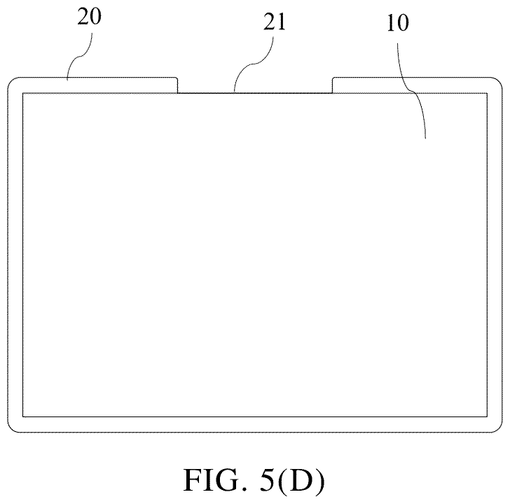

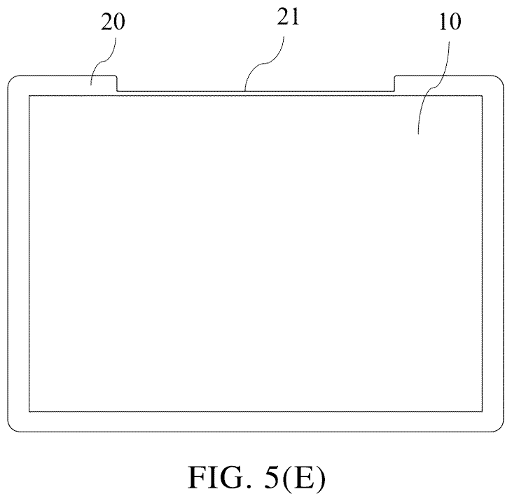

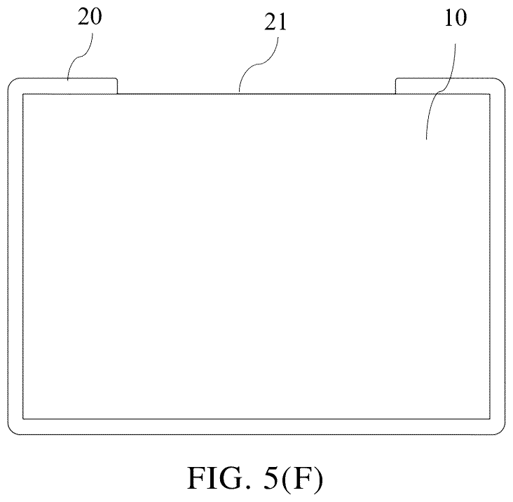

Please refer to FIG. 4(A) to 4(F) and 5(A) to 5(F), FIG. 4(A) to 4(F) are schematic diagrams of notch-type adsorption privacy films according to Embodiments 4-1 to 4-6 of the present invention, in which both sides are beveled, all inner angles are greater than 90 degrees, and the notch widths are narrow, medium, and wide, respectively. FIG. 5(A) to 5(F) are schematic diagrams of notch-type adsorption privacy films according to Embodiments 5-1 to 5-6 of the present invention, in which both side edges are vertical, all inner angles are 90 degrees, and the notch widths are narrow, medium, and wide, respectively. Furthermore, the terms “narrow,” “medium,” and “wide” indicate relative size proportions and are not specifically limited, and may be set as needed.

Further, the privacy films 1 illustrated in FIG. 4(A), 4(C), 4(E), 5(A), 5(C), and 5(E) are designed such that the bottom center of the notch is approximately flush with the top of the electronic device's screen, and a coating layer 20 is arranged around the periphery of the privacy film body 10, forming a substantially closed frame shape with one side having a partial width smaller than the other sides. Additionally, the privacy films illustrated in FIG. 4(B), 4(D), 4(F), 5(B), 5(D), and 5(F) are designed such that the bottom center of the notch is spaced apart from the top of the electronic device's screen by a specified distance, and the coating layer 20 arranged around the periphery of the privacy film body 10 includes at least one open end. The specified distance is not particularly limited and may be set as needed.

As shown in FIG. 4(A) to 4(F) and FIG. 5(A) to 5(F), in the notch-type adsorption privacy films illustrated in Embodiments 4-1 to 4-6 and Embodiments 5-1to 5-6 of the present invention, except that the adsorption member 22 is embedded or buried within the privacy film body 10, or disposed above the privacy film body 10, beneath the coating layer 20, and at an appropriate position within the peripheral region surrounding the privacy film body 10, the overall external structure of the privacy film 1 is substantially the same as that illustrated in Embodiment 1. Similarly, the total number of adsorption members 22 may be one, two, or multiple. The peripheral region refers to the area within a specific distance from each side of the privacy film 1, wherein the specific distance is generally not greater than the size of the electronic device's bezel; preferably, it corresponds to the width of the electronic device's bezel. In this embodiment, by using the adsorption member 22 disposed in the peripheral region, a stronger adsorption force can be further provided to effectively prevent the privacy film from sliding or falling off during use of the electronic device, especially under frequent movement or tilting. Furthermore, the adsorption members 22 arranged around the periphery can flexibly adapt to various device bezel shapes and thicknesses, thereby enhancing applicability.

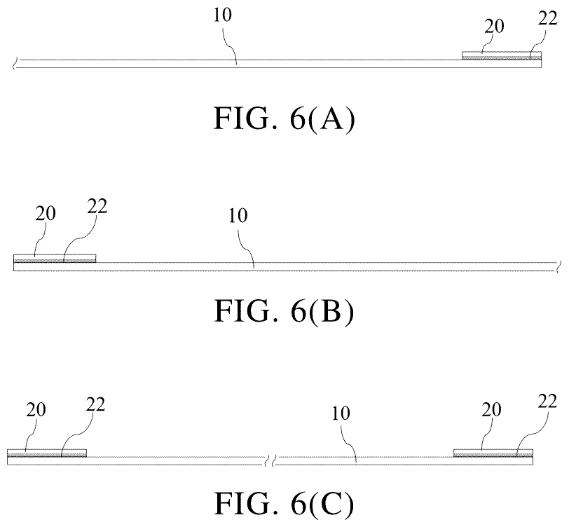

Please refer to FIG. 6(A) to 6(C), FIG. 6(A) to 6(C) are cross-sectional views of notch-type adsorption privacy films according to Embodiments 6-1 to 6-3 of the present invention. As shown in FIG. 6(A) to 6(C), except that the adsorption member 22 is disposed above the privacy film body 10, beneath the coating layer 20, and located at an appropriate position on one side surface of the privacy film body 10, and the total number of adsorption members 22 may be one, two, or multiple, the overall external structure of the privacy film is substantially the same as that illustrated in Embodiment 1. Therefore, descriptions related to the privacy angle of the privacy film 1, the privacy film body 10, the coating layer 20, the adsorption member 22, including their composition, thickness, materials, properties, dimensions, and magnetic force, are omitted herein.

In Embodiment 6-1 of the present invention, shown in FIG. 6(A), the coating layer 20 and the adsorption member 22 are disposed at the upper end of either the front or back surface of the privacy film body 10; in Embodiment 6-2 shown in FIG. 6(B), the coating layer 20 and the adsorption member 22 are disposed at the lower end of either the front or back surface of the privacy film body 10; and in Embodiment 6-3 shown in FIG. 6(C), the coating layer 20 and the adsorption member 22 are disposed at both the upper and lower ends of either the front or back surface of the privacy film body 10.

Furthermore, in the present invention, the coating layer 20 may also be referred to as a protective layer; it is generally not specifically limited and can be appropriately selected according to the final use, required performance, and the type of the object being covered.

For example, in the present invention, materials such as ceramic materials; rubber materials; glass materials; nanomaterials; metal materials including zinc, aluminum, or copper; polymer materials such as epoxy resin, polyurethane, polycarbonate, polyester, or polyacrylate; or other materials may be used. Additionally, methods such as spraying, dipping, rolling, electroplating, powder coating, vapor deposition, hot-dip coating, printing, coating, layer formation, or thin film fabrication; or other methods may be employed to form or produce the coating layer or protective layer.

Furthermore, in Embodiment 6-1 of the present invention shown in FIG. 6(A), since the adsorption member 22 is disposed at the upper end of the privacy film body 10, the notch-type adsorption privacy film of the present invention can be securely adsorbed onto the electronic device, and the user can easily install and remove it. This design is suitable for situations requiring frequent tapping or operation of the lower area of the screen, such as touch functions or keyboard regions. Because the adsorption point is located at the top, the privacy film is less affected by gravity and is less likely to slip off.

Furthermore, in Embodiment 6-2 of the present invention shown in FIG. 6(B), since the adsorption member 22 is disposed at the lower end of the privacy film body 10, the notch-type adsorption privacy film of the present invention can prevent the lower end from lifting, ensuring complete adhesion to the screen and enhancing the privacy protection effect. This design is especially suitable for screen-facing-up usage (e.g., a tablet placed on a table), providing more stable support. If there is a front camera or sensor at the top of the screen, the adsorption member positioned at the bottom can avoid interfering with their functions.

Furthermore, in Embodiment 6-3 of the present invention shown in FIG. 6(C), since the adsorption members 22 are disposed at both the upper and lower ends of the privacy film body 10, the notch-type adsorption privacy film of the present invention can provide more stable adsorption force, preventing movement or lifting at any angle during use. This design is suitable for laptops or tablet devices that require frequent movement, ensuring that the privacy film remains in an optimal position at all times. The dual adsorption at both ends reduces deformation or damage caused by force concentrated at a single point, thereby extending the service life.

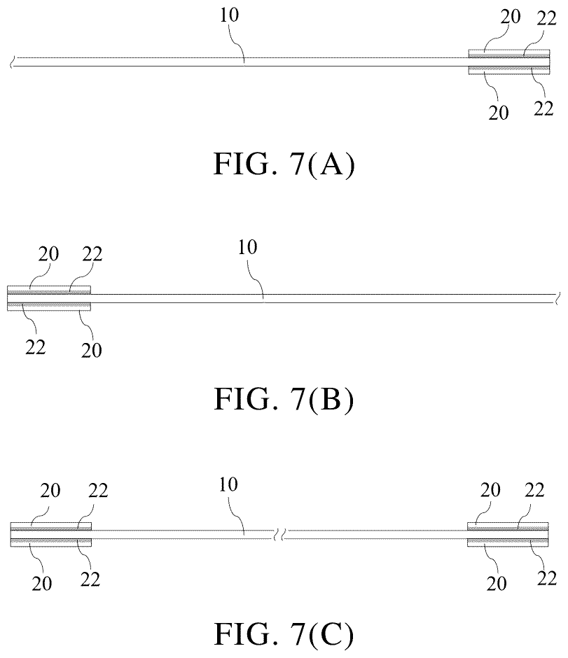

Please refer to FIG. 7(A) to 7(C), FIG. 7(A) to 7(C) are cross-sectional views of notch-type adsorption privacy films according to Embodiments 7-1 to 7-3 of the present invention. As shown in FIG. 7(A) to 7(C), in the notch-type adsorption privacy films of the present invention, except that the adsorption member 22 is disposed above the privacy film body 10, beneath the coating layer 20, and at any appropriate position on both side surfaces of the privacy film body 10, the overall external structure of the privacy film is substantially the same as that illustrated in Embodiment 6. Moreover, the total number of adsorption members 22 may be one, two, or multiple. The overall external structure of the privacy film is also substantially the same as that illustrated in Embodiment 1. Therefore, descriptions related to the privacy angle of the privacy film 1, the privacy film body 10, the coating layer 20, the adsorption member 22, including their composition, thickness, materials, properties, dimensions, and magnetic force, are omitted herein.

In Embodiment 7-1 shown in FIG. 7(A), the coating layer 20 and the adsorption member 22 are disposed at an appropriate position near the upper end of either the front or back surface of the privacy film body 10. Therefore, the notch-type adsorption privacy film of the present invention can be securely adsorbed onto the electronic device and is less likely to slip off. This design is suitable for situations requiring frequent tapping or operation of the lower area of the screen, such as touch functions or keyboard regions.

In Embodiment 7-2 shown in FIG. 7(B), the coating layer 20 and the adsorption member 22 are disposed at the lower end of either the front or back surface of the privacy film body 10. Therefore, the notch-type adsorption privacy film of the present invention can ensure complete adhesion to the screen, prevent lifting at the lower end, and enhance the privacy protection effect. This design is especially suitable for screen-facing-up usage (e.g., a tablet placed on a table), providing more stable support.

The adsorption member 22 may be inherently magnetic or non-magnetic. When the notch-type adsorption privacy film uses an adsorption member 22 with inherent magnetism, due to magnetic attraction, the N and S poles of the adsorption member 22 will automatically magnetically attract to the corresponding polarity positions of the electronic device's screen bezel. Therefore, according to the present invention, the privacy film can automatically position itself at an appropriate location on the electronic device. Moreover, through the adsorption effect, the privacy film of the present invention, the screen of the electronic device, and the keyboard can be tightly sealed without gaps. As a result, after use, the electronic device or screen can be directly closed with the privacy film in place.

Furthermore, since the privacy film, screen, and keyboard are tightly sealed together, the magnetic force of the electronic device's screen magnet corresponding to the keyboard's sleep device can be transmitted through the self-contained magnetic force of the adsorption privacy film to the keyboard's sleep switch. Additionally, according to the present invention, the front and back sides of the notch-type adsorption privacy film can be processed to have slight optical differences. For example, one side may be treated with an anti-glare (AG) process to produce a non-reflective surface that reduces contrast and lessens eye strain, while the other side may be treated with a high-contrast (HC) process to produce a brighter surface with higher color contrast. Thus, when using the notch-type adsorption privacy film with AG and HC sides according to the present invention, the user can select the side with slightly different optical properties according to their needs. For instance, to reduce eye strain during long periods of office work, the AG side can be used; for viewing videos or multimedia, the HC side can be selected.

In Embodiment 7-3 shown in FIG. 7(C), the coating layer 20 and the adsorption member 22 are disposed at both the upper and lower ends of either the front or back surface of the privacy film body 10. The dual adsorption at both ends can reduce deformation or damage caused by force concentrated at a single point, thereby extending the service life. Therefore, the notch-type adsorption privacy film of the present invention can provide more stable adsorption force, preventing movement or lifting at any angle during use, making it suitable for laptops or tablet devices that require frequent movement.

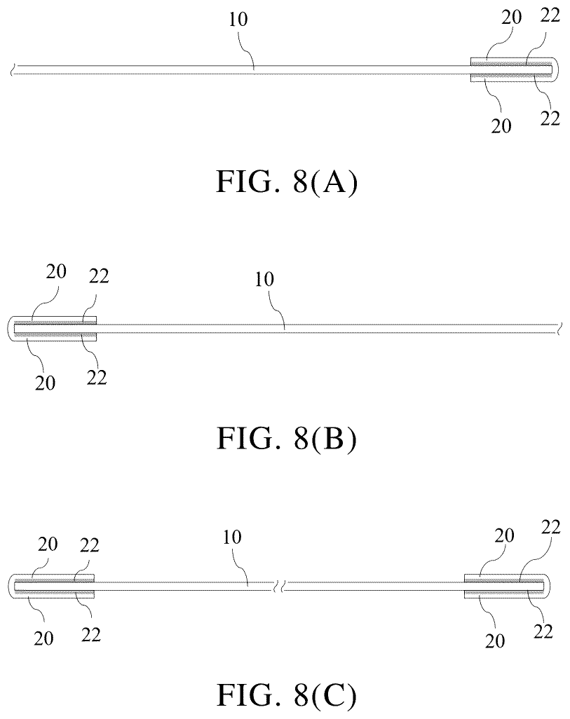

Please refer to FIG. 8(A) to 8(C), FIG. 8(A) to 8(C) are cross-sectional views of notch-type adsorption privacy films according to Embodiments 8-1 to 8-3 of the present invention. It is noteworthy that in Embodiments 7 shown in FIG. 7 and Embodiments 8 shown in FIG. 8(A) to 8(C), the notch-type adsorption privacy films of both embodiments exhibit substantially the same overall external structure. Therefore, in the present Embodiment 8, descriptions related to the privacy angle of the privacy film 1, the privacy film body 10, the coating layer 20, the adsorption member 22, including their composition, thickness, materials, properties, dimensions, and magnetic force, are omitted.

Furthermore, the main difference between the privacy films 1 of Embodiment 7 and Embodiment 8 lies in that, in the privacy film 1 of Embodiment 7, the coating layer 20 does not cover the privacy film body 10 and at least two or more coating layers 20 are provided; whereas in the privacy film 1 of Embodiment 8, at least one coating layer 20 is provided, and the coating layer 20 covers at least a portion of the upper or lower end of the privacy film body 10.

Specifically, in the embodiment 8-1 shown in FIG. 8(A), the coating layer 20 is disposed on the upper ends of the front and rear surfaces of the privacy film body 10, wrapping the upper end of the privacy film body 10 without exposing the adsorption member 22. Therefore, in the embodiment 8-1 of FIG. 8(A), the total number of the coating layers 20 provided is at least one, and the total number of the adsorption members 22 provided is generally at least twice the total number of the coating layers 20. Moreover, in the embodiment 8-2 shown in FIG. 8(B), the coating layer 20 is disposed on the lower ends of the front and rear surfaces of the privacy film body 10, wrapping the lower end of the privacy film body 10 without exposing the adsorption member 22. Therefore, in the embodiment 8-2 of FIG. 8(B), the total number of the coating layers 20 provided is at least one, and the total number of the adsorption members 22 provided is generally at least twice the total number of the coating layers 20.

Specifically, in the embodiment 8-3 shown in FIG. 8(C), the coating layers 20 are respectively disposed on the upper and lower ends of the front and rear surfaces of the privacy film body 10, and respectively wrap the upper and lower ends of the privacy film body 10 without exposing the adsorption members 22. Therefore, in the embodiment 8-3 of FIG. 8(C), the total number of the coating layers 20 provided is at least two, and the total number of the adsorption members 22 provided is generally at least twice the total number of the coating layers 20.

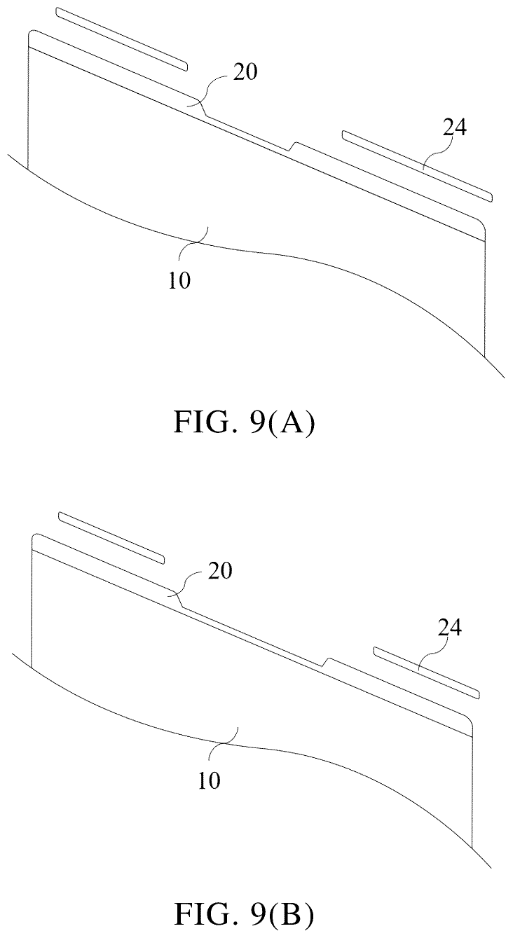

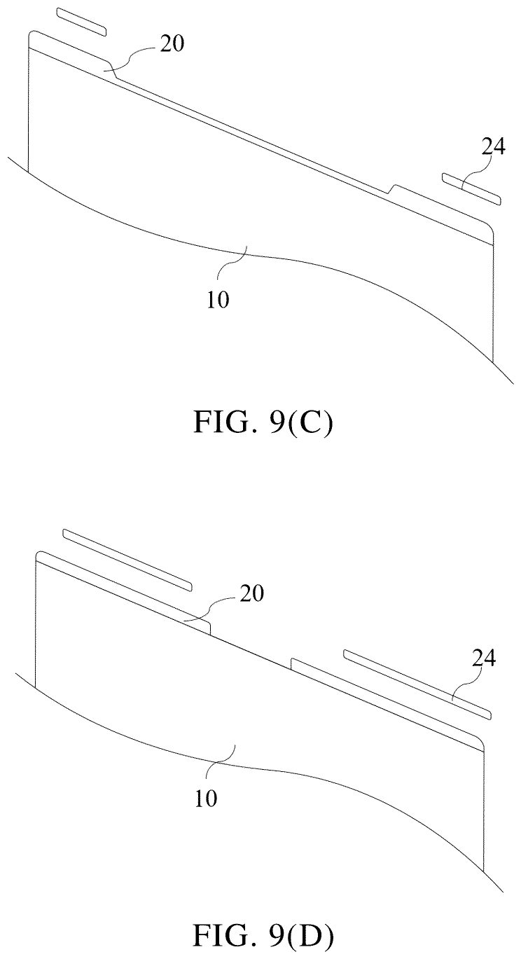

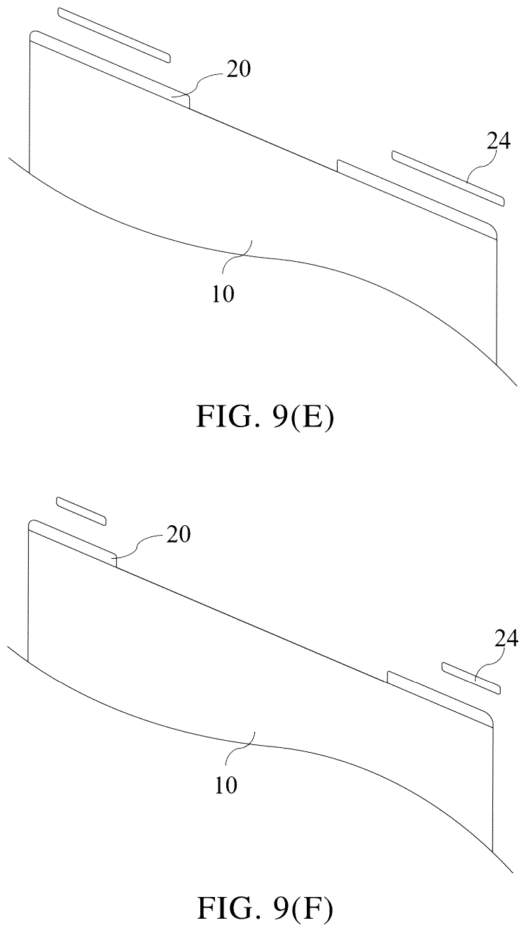

Please refer to FIG. 9(A) to 9(F), FIG. 9(A) to 9(F) are side views illustrating notch-type adsorption privacy films according to embodiments 9-1 to 9-6 of the present invention.

Further, as shown in FIG. 9(A) to 9(F), the notch-type adsorption privacy film of the present invention further includes an auxiliary accessory 24 configured to be disposed on a surface of the privacy film body 10 or on the frame of the electronic device. The auxiliary accessory 24 may have adhesiveness and/or magnetism, or may have neither adhesiveness nor magnetism. Moreover, the auxiliary accessory 24 may further include a fastening member, a hanger member, or a reinforcement member, configured to further secure the privacy film body 10 to the frame of the electronic device.

Please refer to FIG. 10, FIG. 10 is a side view illustrating the notch-type adsorption privacy film according to Embodiment 10 of the present invention.

As shown in FIG. 10, the present invention provides a notch-type adsorption privacy film that can be detachably installed on the exterior of an electronic device to prevent others from viewing the display screen. The adsorption privacy film 1 includes a privacy film body 10 and a coating layer 20. The privacy film body 10 includes, inside thereof, a functional film provided with a plurality of gratings configured to restrict transmitted light within an allowable viewing angle range to define a viewing area, and having a notch 11 at an edge on at least one side. The notch 11 corresponds to the installation position of a functional component of the electronic device, so as to avoid blocking or covering part or all of the functional component. The coating layer 20 is disposed on the privacy film body 10 for covering the surface of the privacy film body 10, and includes an opening 21 corresponding to the notch 11. The coating layer 20, at the embedded slot 12, at least one adsorption member 22 is further provided between the privacy film body 10, which may be magnetic or non-magnetic.

Furthermore, the height LF of the coating layer 20, the height LN of the notch 11, the height LM of the adsorption member 22, and the height LS of the embedded slot 12 satisfy at least one of the following relations (4), (5), and (6):

(4) LF>LM>LS=LN; (4)

(5) LF>LM=LS=LN; (5)

(6) LF=LM>LS=LN. (6)

The adsorption area on the electronic device, to which the notch-type adsorption privacy film can be freely attached and detached, comprises at least one selected from the group consisting of: iron sheets, iron paper, ferromagnetic materials, paramagnetic materials, diamagnetic materials, antiferromagnetic materials, ferrimagnetic materials, and combinations thereof.

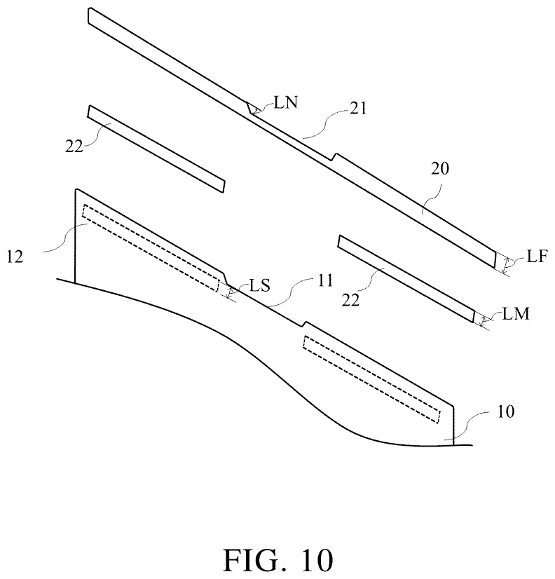

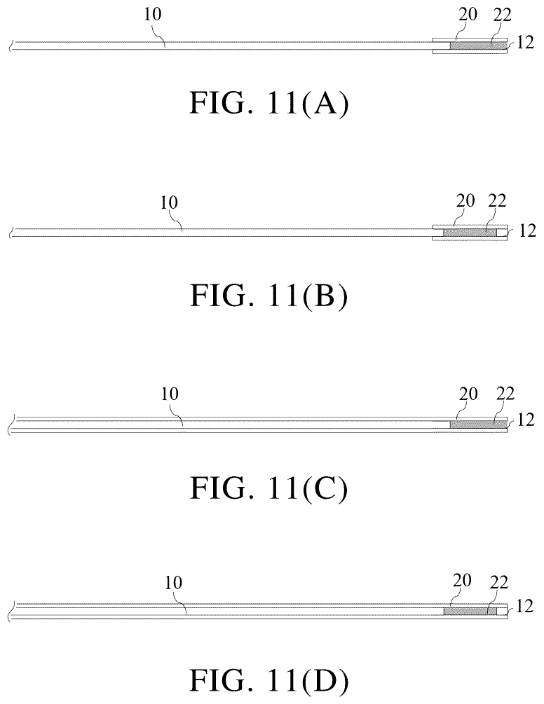

### Please Refer to FIG. 11(A) to 11(D), FIGS. 11(A) to 11(D) Are Cross-sectional Views of the notch-type adsorption privacy films according to embodiments 11-1 to 11-4 of the present invention.

Further, the structure of the notch-type adsorption privacy film illustrated in FIG. 11(A) to 11(D) is substantially the same as that shown in FIG. 7(A) to 7(C), with the main difference being that, as shown in FIG. 11(A), in embodiment 11-1 of the present invention, the embedded slot 12 is arranged such that at least one side is aligned with the edge adjacent to one side of the privacy film body 10.

Further, as shown in FIG. 11(B), the main difference lies in that, in embodiment 11-2, the embedded slot 12 is arranged so as not to be adjacent to any edge of the privacy film body 10.

Further, as shown in FIG. 11(C), the main difference lies in that, in embodiment 11-3, the coating layer 20 completely covers the surface of the privacy film body 10, and the embedded slot 12 is arranged to be adjacent to at least one edge of the privacy film body 10.

Further, as shown in FIG. 11(D), the main difference lies in that, in embodiment 11-4, the coating layer 20 completely covers the surface of the privacy film body 10, and the embedded slot 12 is arranged so as not to be adjacent to any edge of the privacy film body 10.

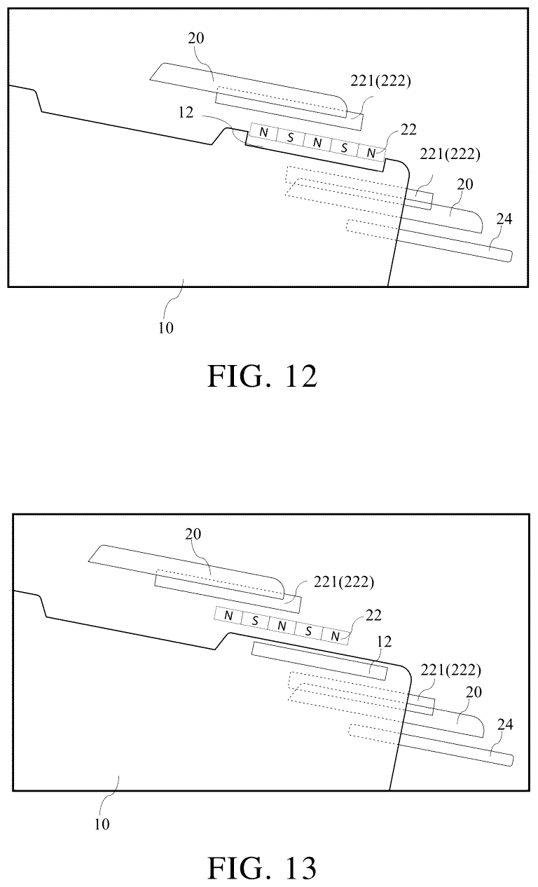

Please refer to FIG. 12, FIG. 12 is a partial exploded schematic view of the notch-type adsorption privacy film according to embodiment 12 of the present invention. In embodiment 12 of the present invention, as shown in FIG. 12, the embedded slot 12 is arranged such that at least one side is aligned with the edge adjacent to one side of the privacy film body 10. The adsorption member 22 is embedded in the embedded slot 12 to prevent displacement or detachment caused by vibration or external force. The adsorption member 22 is a multilayer structure composed of at least one selected from magnetic materials such as magnets, iron pieces, single-sided multipole magnetic iron, double-sided multipole magnetic iron, or their combinations, along with a first wave-absorbing magnetic guiding film 221 and/or a second wave-absorbing magnetic guiding film 222 disposed above or below it. Moreover, the notch-type adsorption privacy film of embodiment 12 of the present invention can be further securely installed on an electronic device by using an auxiliary accessory 24.

Please refer to FIG. 13, FIG. 13 is a partial exploded schematic view of the notch-type adsorption privacy film according to embodiment 13 of the present invention. In embodiment 13, the embedded slot 12 is disposed near the edge of one side of the privacy film body 10 and is not adjacent to any side edges. The adsorption member 22 is securely embedded in the embedded slot 12 to prevent displacement or detachment caused by vibration or external force. The adsorption member 22 is a multilayer structure composed of at least one selected from magnetic materials such as magnets, iron pieces, single-sided multipole magnetic iron, double-sided multipole magnetic iron, or their combinations, along with a first wave-absorbing magnetic guiding film 221 and/or a second wave-absorbing magnetic guiding film 222 disposed above or below it. Moreover, the notch-type adsorption privacy film of embodiment 13 can be further securely installed on an electronic device by using an auxiliary accessory 24.

In summary, the placement of the adsorption members 22 in the notch-type adsorption privacy film of the present invention can be flexibly configured according to needs to provide optimal user experience and stability. First, when the adsorption members 22 are arranged at the upper end of the privacy film body 10, they can be securely adsorbed onto the device surface by a hanging manner. Since the adsorption points are located above, the privacy film body is less affected by gravity and is less likely to slip, allowing users to easily install and remove it, thus facilitating operation. Second, arranging the adsorption members 22 at the lower end of the privacy film body 10 can effectively prevent the lower end from lifting, ensuring complete adhesion of the privacy film to the device screen, thereby enhancing the privacy effect. Furthermore, when the adsorption members 22 are disposed at both the upper and lower ends of the privacy film body 10, a more stable adsorption force can be provided, further enhancing the stability of the privacy film during use, preventing movement or lifting from any angle, and ensuring stability and privacy protection during prolonged use. The configuration of the notch-type adsorption privacy film in the present invention not only improves ease of use but also optimizes stability and adhesion, effectively enhancing the user experience and reliability of the privacy function.

All aspects of the embodiments disclosed herein are illustrative and should not be regarded as limiting. The scope of the present invention is not limited to the foregoing description, but should be defined by the claims, and is intended to include all modifications within the equivalent meaning and scope of the claims.

What is claimed is:

1. A notch-type adsorption privacy film, which is detachably installed on the exterior of an electronic device to prevent others from viewing a display screen, the adsorption privacy film comprising:
a privacy film body including, inside thereof, a functional film provided with a plurality of gratings configured to restrict transmitted light within an allowable viewing angle range to define a viewing area, and having a notch at an edge on at least one side, the notch corresponding to the installation position of a functional component of the electronic device so as to avoid blocking or covering part or all of the functional component; and
a coating layer disposed above the privacy film body for covering the surface of the privacy film body and having an opening corresponding to the notch;
wherein at least one adsorption member having magnetic or non-magnetic properties is additionally disposed between the privacy film body and the coating layer;
wherein the adsorption member being either a single-layer structure consisting only of a magnetic material layer formed of a magnetic material, or a multilayer structure comprising at least one magnetic material layer formed of a magnetic material and at least one other material layer formed of a different material;
wherein the magnetic material in the adsorption member is selected from at least one material of iron sheets, iron paper, ferromagnetic materials, paramagnetic materials, diamagnetic materials, antiferromagnetic materials, ferrimagnetic materials, and combinations thereof; and the height LF of the coating layer,
wherein the height LN of the notch, and the height LM of the adsorption member satisfy at least one of the following relationships:
LF>LM>LN; (1)
LF>LM=LN; (2)
LF=LM≥LN. (3)

2. The notch-type adsorption privacy film according to claim 1, wherein the adsorption member is a multilayer structure formed by laminating a first wave-absorbing magnetic film, a magnetic material, and a second wave-absorbing magnetic film;
wherein the first wave-absorbing magnetic film and the second wave-absorbing magnetic film each have at least one substrate selected from PET film, PU film, PC film, TAC film, and combinations thereof.

3. The notch-type adsorption privacy film according to claim 1, wherein the adsorption member is circular, triangular, rectangular, square, fan-shaped, L-shaped, polygonal, or a combination thereof.

4. The notch-type adsorption privacy film according to claim 1, wherein the thickness of the adsorption member is between 0.1 mm and 1.0 mm.

5. The notch-type adsorption privacy film according to claim 1, wherein the number of adsorption members is one, two, or three or more.

6. The notch-type adsorption privacy film according to claim 1, wherein the magnetic force of the adsorption member is in the range of 200 Gauss to 3500 Gauss.

7. The notch-type adsorption privacy film according to claim 1, wherein the gratings are louver-type privacy microstructures.

8. The notch-type adsorption privacy film according to claim 1, wherein the front viewing angle of the notch-type adsorption privacy film is between ±15° and ±75°.

9. The notch-type adsorption privacy film according to claim 1, further comprising an auxiliary accessory for fixedly installing the privacy film onto the electronic device, wherein the auxiliary accessory is a fastening member or a fixing structure.

10. The notch-type adsorption privacy film according to claim 1, wherein the electronic device is a wearable electronic device, portable smart device, smartphone, mobile phone, tablet, notebook computer, or desktop computer.

11. A notch-type adsorption privacy film, which is detachably installed on the exterior of an electronic device to prevent others from viewing a display screen, the notch-type adsorption privacy film comprising:
a privacy film body including, inside thereof, a functional film provided with a plurality of gratings configured to restrict transmitted light within an allowable viewing angle range to define a viewing area, and having at least one notch at the edge on at least one side, and at least one embedded slot formed in a functional film, the notch corresponding to the installation position of a functional component of the electronic device so as to avoid blocking or covering part or all of the functional component; and
a coating layer disposed above the privacy film body for covering the surface of the privacy film body and having an opening corresponding to the notch;
wherein the coating layer, at the embedded slot, at least one adsorption member having magnetic or non-magnetic properties is further provided between the privacy film body;
wherein the adsorption member is either a single-layer structure consisting only of a magnetic material layer formed of a magnetic material, or a multilayer structure comprising at least one magnetic material layer formed of a magnetic material and at least one other material layer formed of a different material;
wherein the magnetic material in the adsorption member is selected from at least one material of iron sheets, iron paper, ferromagnetic materials, paramagnetic materials, diamagnetic materials, antiferromagnetic materials, ferrimagnetic materials, and combinations thereof;
wherein the height LF of the coating layer the height LN of the notch, the height LM of the adsorption member, and the height LS of the embedded slot satisfy at least one of the following relations:
LF>LM>LS=LN; (4)
LF>LM=LS=LN; (5)
LF=LM>LS=LN. (6)

12. The notch-type adsorption privacy film according to claim 11, wherein the embedded slot is arranged such that at least one side is aligned with the edge adjacent to one side of the privacy film body; or the embedded slot is arranged so as not to be adjacent to any side edge of the privacy film body.

13. The notch-type adsorption privacy film according to claim 11, wherein the adsorption member is a multilayer structure sequentially laminated by a first wave-absorbing magnetic film, a magnetic material, and a second wave-absorbing magnetic film;
wherein the first wave-absorbing magnetic guiding film and the second wave-absorbing magnetic guiding film each have at least one substrate selected from PET film, PU film, PC film, and TAC film.

14. The notch-type adsorption privacy film according to claim 11, wherein the adsorption member is circular, triangular, rectangular, square, fan-shaped, L-shaped, polygonal, or a combination thereof.

15. The notch-type adsorption privacy film according to claim 11, wherein the thickness of the adsorption member is between 0.1 mm and 1.0 mm.

16. The notch-type adsorption privacy film according to claim 11, wherein the number of adsorption members is one, two, or three or more.

17. The notch-type adsorption privacy film according to claim 11, wherein the magnetic force of the adsorption member is in the range of 200 Gauss to 3500 Gauss.

18. The notch-type adsorption privacy film according to claim 11, wherein the gratings are louver-type privacy microstructures.

19. The notch-type adsorption privacy film according to claim 11, wherein the front viewing angle of the notch-type adsorption privacy film is between ±15° and ±75°.

20. The notch-type adsorption privacy film according to claim 11, wherein the electronic device is a wearable electronic device, portable smart device, smartphone, mobile phone, tablet, notebook computer, or desktop computer.

21. The notch-type adsorption privacy film according to claim 11, further comprising an auxiliary accessory for securely installing the privacy film onto the electronic device, wherein the auxiliary accessory is a fastening member or a fixing structure.
